(19) United States
(12) Patent Application Publication
(10) Pub. No.: US 2009/0185128 A1
(43) Pub. Date: Jul. 23, 2009

(54) ACTIVE DEVICE ARRAY SUBSTRATE, COMMON ELECTRODE SUBSTRATE, AND REFLECTIVE TYPE LIQUID CRYSTAL PANEL

(75) Inventor: Shun-Tai Huang, Tainan County (TW)

Correspondence Address: J C PATENTS, INC., 4 VENTURE, SUITE 250, IRVINE, CA, 92618, US

(73) Assignee: Himax Display, Inc., Tainan County (TW)

(21) Appl. No.: 12/018,614

(22) Filed: Jan. 23, 2008

(51) Int. Cl. G02F 1/1339

(52) U.S. Cl. 349/155

(57) ABSTRACT

An active device array substrate including a substrate, a plurality of active devices, and a plurality of spacers is provided. The substrate has a first surface. The active devices are arranged in an array on the first surface. The spacers are disposed over the first surface. Each of the spacers has two side surfaces opposite to each other. A first normal vector of the first surface and a second normal vector of each of the side surfaces make an angle falling within a range from 40 degrees to 70 degrees. Each of the two second normal vectors points away from the first surface. The active device array substrate has a rubbing direction, and a rubbing vector along the rubbing direction and the two second normal vectors of the side surfaces are coplanar. A common electrode substrate and a reflective type liquid crystal panel are also provided.

### BACKGROUND OF THE INVENTION

1. Field of the Invention

The present invention generally relates to a display panel and the substrates thereof. More particularly, the present invention relates to a reflective type liquid crystal panel, an active device array substrate, and a common electrode substrate.

2. Description of Related Art

A conventional liquid-crystal-on-silicon panel (LCOS panel) includes an active device array substrate, a common electrode substrate, and a liquid crystal layer disposed between the active device array substrate and the common electrode substrate. There are spacers disposed on the edge of the LCOS panel and between the active device array substrate and the common electrode substrate to keep a gap between the active device array substrate and the common electrode substrate, such that the liquid crystal layer is able to be contained in the gap.

A kind of spacer is a fiber and silica ball. The fiber and silica balls are mixed in a sealant and then applied to the edge of the active device array substrate. When the fiber and silica balls are mixed and stirred in a sealant, bubbles may be generated in the sealant, and the fiber and silica balls may not be mixed uniformly in the sealant, which lowers the reliability of the LCOS panel.

Another kind of spacer is made by semiconductor process. FIG. 1A is a schematic top view of a conventional active device array substrate having spacers made by semiconductor process, and FIG. 1B is a cross-sectional view of the conventional active device array substrate in FIG. 1A taken along line I-I. Referring to FIGS. 1A and 1B, a conventional active device array substrate 100 includes a substrate 110, a plurality of transistors 120, a plurality of spacers 130, a patterned metal layer 140, and an alignment layer 150. The substrate 110 has a surface 112. The surface 112 has a display region 114 and a peripheral region 116. The transistors 120 are disposed at the surface 112. The patterned metal layer 140 is disposed on the surface 112 and covers the transistors 120. The spacers 130 are disposed on the patterned metal layer 140 and within the peripheral region 116. The alignment layer 150 covers the patterned metal layer 140 and the spacers 130.

After the alignment layer 150 are coated over the substrate 110, a roller 50 having rubbing fibers (not shown) on its surface rolls over and rubs the alignment layer 150, such that the molecules of the alignment layer 150 is aligned, which render liquid crystal molecules (not shown) on the alignment layer 150 to be aligned. However, in the conventional active device array substrate 100, each side surface 132 and the top surface 134 of each spacer 130 make a right angle. The right angle damages the rubbing fibers of the roller 50 when the roller 50 rolls over and rubs the alignment layer 150. After the rubbing fibers are damaged, they can not align the molecules of the alignment layer 150 normally, so as to lower the quality of the alignment layer 150.

### SUMMARY OF THE INVENTION

Accordingly, the present invention is directed to an active device array substrate, which reduces the damage of the roller used in a rubbing process.

The present invention is directed to a common electrode substrate, which reduces the damage of the roller used in a rubbing process.

The present invention is directed to a reflective type liquid crystal panel, alignment layers of which have good quality.

According to an embodiment of the present invention, an active device array substrate including a substrate, a plurality of active devices, and a plurality of spacers is provided. The substrate has a first surface. The active devices are arranged in an array on the first surface. The spacers are disposed over the first surface. Each of the spacers has two side surfaces opposite to each other. The first surface faces the spacers. A first normal vector of the first surface and a second normal vector of each of the side surfaces make an angle falling within a range from 40 degrees to 70 degrees. Each of the two second normal vectors points away from the first surface. The active device array substrate has a rubbing direction, and a rubbing vector along the rubbing direction and the two second normal vectors of the side surfaces are coplanar.

According to another embodiment of the present invention, a common electrode substrate including a substrate, a common electrode layer, and a plurality of spacers is provided. The substrate has a second surface. The common electrode layer is disposed on the second surface. The spacers are disposed on the common electrode layer. Each of the spacers has two side surfaces opposite to each other. A first normal vector of the second surface and a second normal vector of each of the side surfaces make an angle falling within a range from 40 degrees to 70 degrees. Each of the two second normal vectors points away from the second surface. The common electrode substrate has a rubbing direction, and a rubbing vector along the rubbing direction and the two second normal vectors of the side surfaces are coplanar.

According to another embodiment of the present invention, a reflective type liquid crystal panel including the above active device array substrate, a common electrode substrate, and a liquid crystal layer is provided. The active device array substrate further includes a first alignment layer. The first alignment layer is disposed over the first substrate and the active devices and covers the spacers. The first alignment layer has an alignment direction corresponding to the rubbing direction. The common electrode substrate includes a substrate, a common electrode layer, and a second alignment layer. The substrate of the common electrode substrate has a second surface facing the active device array substrate. The common electrode layer is disposed on the second surface. The second alignment layer is disposed on the common electrode layer. The liquid crystal layer is disposed between the first alignment layer and the second alignment layer.

According to another embodiment of the present invention, a reflective type liquid crystal panel including an active device array substrate, the above common electrode substrate which has the spacers, and a liquid crystal layer is provided. The active device array substrate includes a substrate, a plurality of active devices, and a first alignment layer. The substrate has a first surface. The active devices are arranged in an array on the first surface. The first alignment layer is disposed over the substrate of the active device array substrate and the active devices. The first surface faces the first alignment layer. The common electrode substrate further includes a second alignment layer. The second alignment layer is disposed on the common electrode layer and covers the spacers. The second alignment layer has an alignment direction corresponding to the rubbing direction. The liquid crystal layer is disposed between the first alignment layer and the second alignment layer.

In the active device array substrate or the common electrode substrate of an embodiment of the present invention, the side surfaces of the spacers are inclined with respect to the first or second surface of the substrate, so as to reduce the damage of the roller used in a robbing process. Therefore, a reflective type liquid crystal panel using the active device array substrate or the common electrode substrate has alignment layers well aligned, which improves the quality of the alignment layers.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic top view of a conventional active device array substrate having spacers made by semiconductor process.

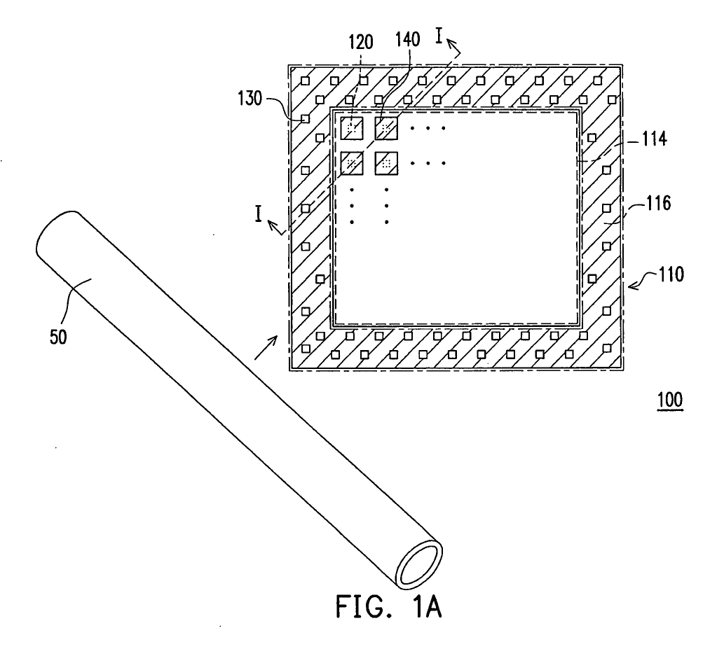

FIG. 1B is a cross-sectional view of the conventional active device array substrate in FIG. 1A taken along line I-I.

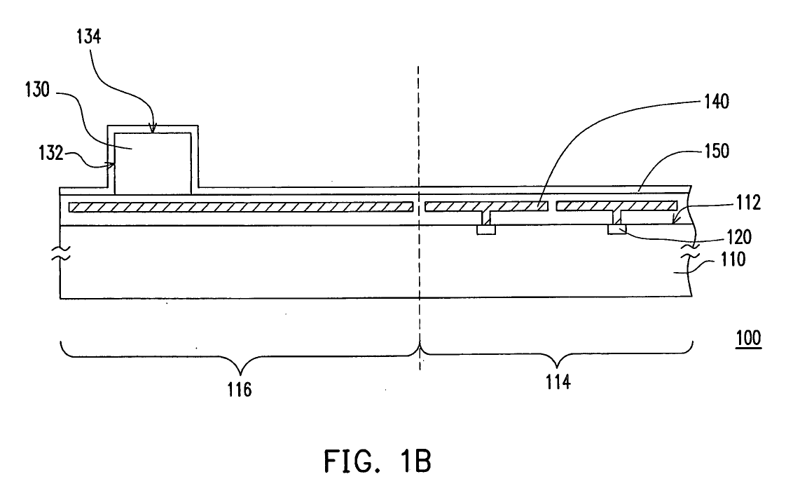

FIG. 2A is a schematic top view of an active device array substrate according to an embodiment of the present invention.

FIG. 2B is a cross-sectional view of the active device array substrate in FIG. 2A taken along line II-II.

FIG. 3 is a schematic cross-sectional view of a reflective type liquid crystal panel according to an embodiment of the present invention.

FIG. 4A is a schematic top view of a common electrode substrate according to an embodiment of the present invention.

FIG. 4B is a cross-sectional view of the common electrode substrate in FIG. 4A taken along line III-III.

FIG. 5 is a schematic cross-sectional view of a reflective type liquid crystal panel according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

It should be noted that the normal vector of a surface of any element in the description of the present invention is defined as a vector which is perpendicular to the surface and points from the inside of the element to the outside of the element through the surface.

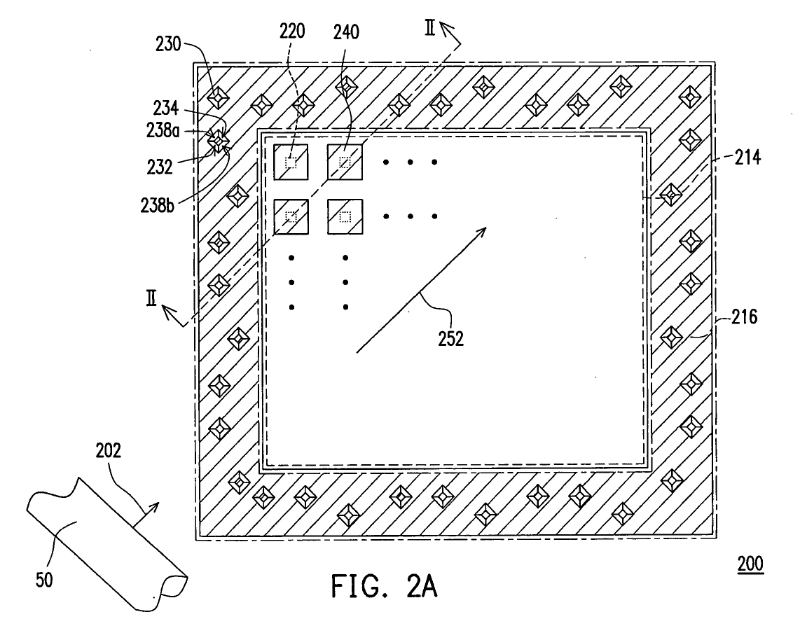

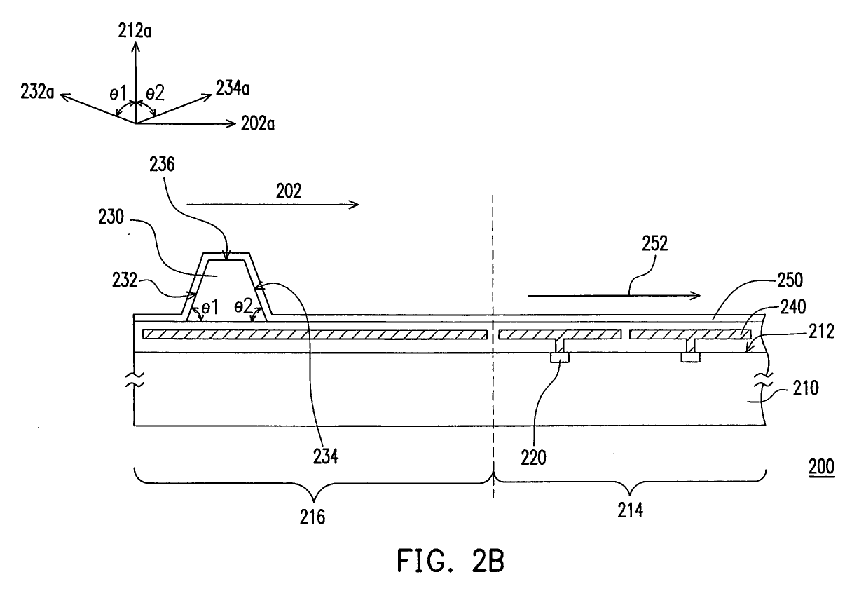

FIG. 2A is a schematic top view of an active device array substrate according to an embodiment of the present invention, and FIG. 2B is a cross-sectional view of the active device array substrate in FIG. 2A taken along line II-II. Referring to FIGS. 2A and 2B, an active device array substrate 200 according to the present embodiment can be applied in a reflective type liquid crystal panel, for example, an LCOS panel. The active device array substrate 200 includes a substrate 210, a plurality of active devices 220, and a plurality of spacers 230. In the present embodiment, the substrate 210 is, for example, a silicon substrate. The substrate 210 has a first surface 212. The active devices 220 are arranged in an array on the first surface 212. In the present embodiment, the active devices 220 are, for example, transistors or other appropriate active devices. The spacers 230 are disposed over the first surface 212, and the first surface 212 faces the spacers 230. In the present embodiment, the first surface 212 of the substrate 210 has a display region 214 and a peripheral region 216 around the display region 214. The active devices 220 are located within the display region 214, and the spacers 230 are located within the peripheral region 216 and surround the display region 214.

In the present embodiment, the active device array substrate 200 further includes at least one patterned metal layer 240 disposed between the substrate 210 and the spacers 230, and located over the active devices 220. Additionally, in the present embodiment, the active device array substrate 200 further includes an alignment layer 250 disposed over the substrate 210 and the active devices 220 and covers the spacers 230. In detail, the alignment layer 250 is disposed on the patterned metal layer 240 and covers the spacers 230.

Each of the spacers 230 has two side surfaces 232 and 234 opposite to each other. In the present embodiment, each of the spacers 230 further has a top surface 236 connecting the two side surfaces 232 and 234. A first normal vector 212a of the first surface 212 and a second normal vector 232a of the side surface 232 make an angle θ1 falling within a range from 40 degrees to 70 degrees. Additionally, the first normal vector 212a of the first surface 212 and a second normal vector 234a of the side surface 234 make an angle θ2 falling within a range from 40 degrees to 70 degrees. Each of the two second normal vectors 232a and 234a points away from the first surface 212. In other words, the side surface 232 has an inclined angle θ1 with respect to the first surface 212, and is inclined with respect to the top surface 236. In addition, the side surface 234 has an inclined angle θ2 with respect to the first surface 212, and is inclined with respect to the top surface 236. In the present embodiment, the angle θ1 is substantially equal to the angle θ2. However, in other embodiments (not shown), the angle θ1 may also be unequal to the angle θ2.

The active device array substrate 200 has a rubbing direction 202. In the present embodiment, the alignment layer 250 has an alignment direction 252 corresponding to the rubbing direction 202, in which the alignment direction 252 is related to the orientations of the molecules of the alignment layer 250. In a rubbing process, a roller 50 rolls over the alignment layer 250 along the rubbing direction 202 and rubs the alignment layer 250, and then the molecules of the alignment layer 250 are reoriented according to the alignment direction 252, such that the liquid crystal molecules (not shown) on the alignment layer 250 are aligned according to the alignment direction 252. Moreover, a rubbing vector 202a along the rubbing direction 202 and the two second normal vectors 232a and 234a of the side surfaces 232 and 234 are coplanar. In other words, before the roller 50 rolls over and rubs a spacer 230, one of the side surfaces 232 and 234 faces the roller 50, and the other faces away from the roller. Additionally, the side surfaces 232 and 234 are inclined with respect to the first surface 212 and the top surface 236, such that the damage of the roller 50, for example, the damage of the rubbing fibers (not shown) on the surface of the roller 50, is reduced when the roller 50 rolls over and rubs the spacers 230. Therefore, the alignment layer 250 is normally aligned after rubbing process, so as to improve the quality of the alignment layer 250.

The spacers 230 may be manufactured by a semiconductor process, and the inclination of the side surfaces 232 and 234 with respect to the first surface 212 and the top surface 236 may be achieved by fine tune in the semiconductor process. The semiconductor process includes a photolithography process, a thin film deposition process, an etching process, other related processes, or the combination thereof. In the present embodiment, the inclination of the side surfaces 232 and 234 is achieved by fine tune in an etching process.

In the present embodiment, the top surface 236 is in a rectangular shape. However, in other embodiment (not shown), the top surface may be in other shapes. For example, the top surface is in a polygonal shape, a circular shape, or the like. In addition, each of the spacers 230 may have other side surfaces, such as side surfaces 238a and 238b. It should be noted that the number of the side surfaces of each of the spacers is not limited to four in the present invention. In other embodiments (not shown), the number of the side surfaces of each of the spacers may be a natural number other than four.

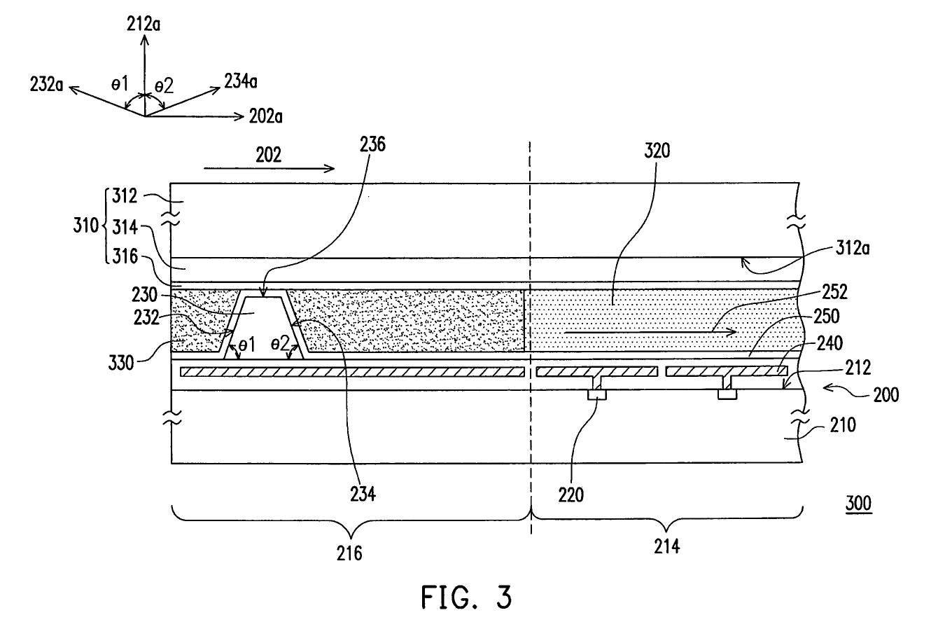

FIG. 3 is a schematic cross-sectional view of a reflective type liquid crystal panel according to an embodiment of the present invention. Referring to FIG. 3, a reflective type liquid crystal panel 300 according to the present embodiment is, for example, an LCOS panel. The reflective type liquid crystal panel 300 includes the above active device array substrate 200, a common electrode substrate 310, and a liquid crystal layer 320. The common electrode substrate 310 includes a substrate 312, a common electrode layer 314, and an alignment layer 316. The substrate 312 has a second surface 312a facing the active device array substrate 200. In the present embodiment, the substrate 312 is transparent, and is, for example, a fused silica substrate, a glass substrate, or other transparent substrates. The common electrode layer 314 is disposed on the second surface 312a. The alignment layer 316 is disposed on the common electrode layer 314. The liquid crystal layer 320 is disposed between the alignment layer 250 and the alignment layer 316.

In the present embodiment, a sealant 330 is disposed between the active device array substrate 200 and the common electrode substrate 310. The sealant 330 wraps the spacers 230 and surrounds the liquid crystal layer 320, so that the liquid crystal molecules of the liquid crystal layer 320 can be contained between the active device array substrate 200 and the common electrode substrate 310.

Because there is no spacer disposed between the substrate 312 and the alignment layer 316, when the alignment layer 316 is rubbed by the roller 50 as shown in FIG. 2A, the roller 50 will not be damaged by spacers. Therefore, the alignment 316 is well aligned and has good quality. Since the quality of both the alignment layer 250 and the alignment 316 is good, the yield of the reflective type liquid crystal panel 300 is high, and the quality thereof is good.

The spacers are not limited to be formed in an active device array substrate in the present invention, but they may also be formed in a common electrode substrate, which will be described in the following embodiments.

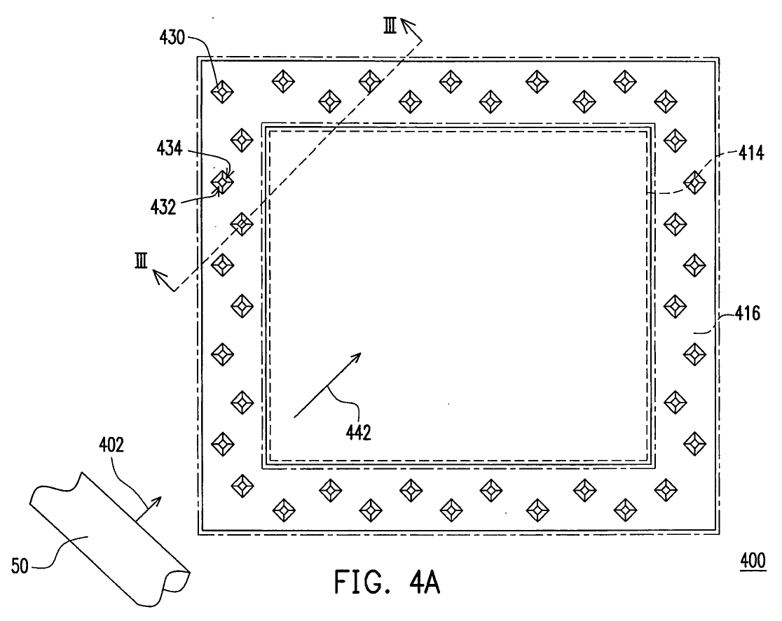

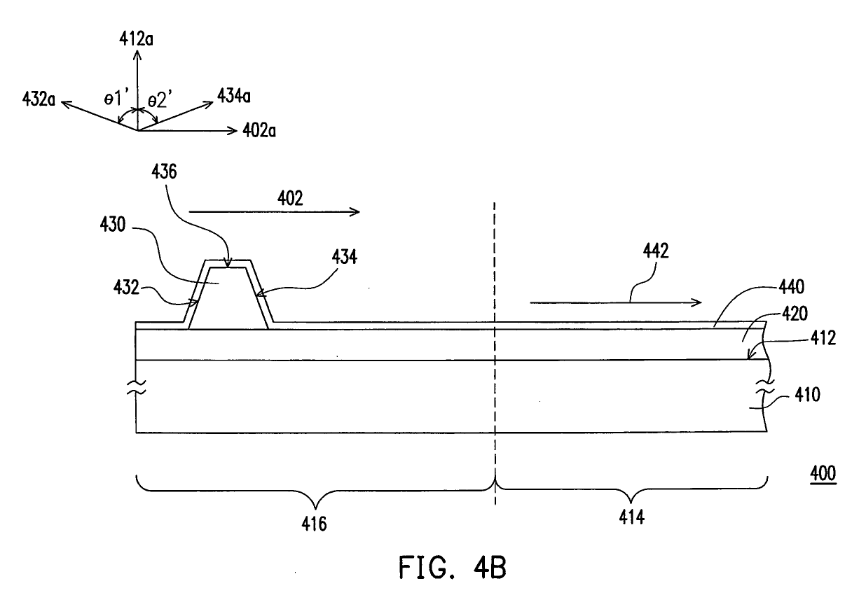

FIG. 4A is a schematic top view of a common electrode substrate according to an embodiment of the present invention, and FIG. 4B is a cross-sectional view of the common electrode substrate in FIG. 4A taken along line III-III. Referring to FIGS. 4A and 4B, a common electrode substrate 400 according to the present embodiment includes a substrate 410, a common electrode layer 420, and a plurality of spacers 430. The substrate 410 has a second surface 412. In the present embodiment, the substrate 410 is transparent, and is, for example, a fused silica substrate, a glass substrate, or other transparent substrates. The common electrode layer 420 is disposed on the second surface 412. The spacers 430 are disposed on the common electrode layer 420. In the present embodiment, the second surface 412 of the substrate 410 has a display region 414 and a peripheral region 416 around the display region 414. The spacers 430 are located within the peripheral region 416 and surround the display region 414. Moreover, in the present embodiment, the common electrode substrate 400 further includes an alignment layer 440 disposed on the common electrode layer 420 and covering the spacers 430.

The spacers 430 are similar to the above spacers 230 in FIGS. 2A and 2B. Each of the spacers 430 has two side surfaces 432 and 434 opposite to each other. In the present embodiment, each of the spacers 430 further has a top surface 436 connecting the two side surfaces 432 and 434. A first normal vector 412a of the second surface 412 and a second normal vector 432a of the side surface 432 make an angle θ1′ falling within a range from 40 degrees to 70 degrees. Additionally, the first normal vector 412a of the second surface 412 and a second normal vector 434a of the side surface 434 make an angle θ2′ falling within a range from 40 degrees to 70 degrees. In the present embodiment, the angle θ1′ is substantially equal to the angle θ2′. However, in other embodiments (not shown), the angle θ1′ may also be unequal to the angle θ2′. Each of the two second normal vectors 432a and 434a points away from the second surface 412. The common electrode substrate 400 has a rubbing direction 402. In the present embodiment, the alignment layer 440 has an alignment direction 442 corresponding to the rubbing direction 402. A rubbing vector 402a along the rubbing direction 402 and the two second normal vectors 432a and 434a of the side surfaces 432 and 434 are coplanar.

It is similar to the case of the above active device array substrate 200 having spacers 230 shown in FIGS. 2A and 2B that the side surfaces 432 and 434 are inclined with respect to the second surface 412 and the top surface 436, and one of the side surfaces 432 and 434 faces the roller 50 and the other faces away from the roller 50 before the roller 50 rolls over and rubs a spacers 430, such that the damage of the roller 50 is reduced when the roller 50 rolls over and rubs the alignment layer 440. Therefore, the alignment layer 440 is well aligned, such that the quality of the alignment layer 440 is good.

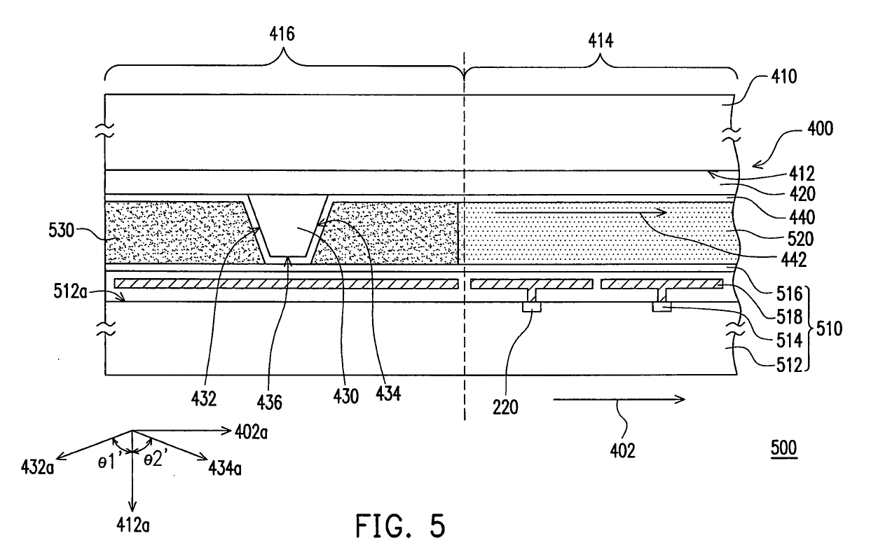

FIG. 5 is a schematic cross-sectional view of a reflective type liquid crystal panel according to another embodiment of the present invention. Referring to FIG. 5, a reflective type liquid crystal panel 500 in the present embodiment includes an active device array substrate 510, the above common electrode substrate 400, and a liquid crystal layer 520. The active device array substrate 510 includes a substrate 512, a plurality of active devices 514, and an alignment layer 516. The substrate 512 has a first surface 512a. In the present embodiment, the substrate 512 is, for example, a silicon substrate. The active devices 514 are arranged in an array on the first surface 512a. In the present embodiment, the display region 414 of the second surface 412 of the substrate 410 is corresponding to the active devices 514. In other words, the active devices 514 are disposed within a region of the first surface 512a opposite to the display region 414. The alignment layer 516 is disposed over the substrate 512 and the active devices 514, and the first surface 512a faces the alignment layer 516.

In the present embodiment, the active device array substrate 510 further includes at least one patterned metal layer 518 disposed between the substrate 512 and the alignment layer 516 and over the active devices 514. Additionally, in the present embodiment, the reflective type liquid crystal panel 500 further includes a sealant 530 disposed between the active device array substrate 510 and the common electrode substrate 400. The sealant 530 wraps the spacers 430 and surrounds the liquid crystal layer 520.

Since there is no spacer disposed between the alignment layer 516 and the substrate 512, the roller 50 as shown in FIG. 4A is not damaged by spacers in the robbing process. Therefore, the alignment layer 516 is well aligned after the rubbing process, such that the quality of the alignment layer 516 is good. Since the quality of both the alignment layers 516 and 440 is good, the yield of the reflective type liquid crystal panel 500 is high, and the quality thereof is good.

To sum up, in the active device array substrate according to an embodiment of the present invention or in the common electrode substrate according to another embodiment of the present invention, the two side surfaces of each spacer are inclined with respect to the first or second surface of the substrate, and one of the side surfaces faces the roller for rubbing and the other faces away from the roller before the roller rolls over and rubs the spacer, so as to reduce the damage of the roller used in a robbing process. Therefore, a reflective type liquid crystal panel using the active device array substrate or the common electrode substrate has alignment layers well aligned, which improves the quality of the alignment layers, so as to improve the yield and the quality of the reflective type liquid crystal panel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An active device array substrate, comprising:
a substrate, having a first surface;
a plurality of active devices, arranged in an array on the first surface; and
a plurality of spacers, disposed over the first surface, each of the spacers having two side surfaces opposite to each other, wherein the first surface faces the spacers, a first normal vector of the first surface and a second normal vector of each of the side surfaces make an angle falling within a range from 40 degrees to 70 degrees, each of the two second normal vectors points away from the first surface, the active device array substrate has a rubbing direction, and a rubbing vector along the rubbing direction and the two second normal vectors of the side surfaces are coplanar.

2. The active device array substrate as claimed in claim 1, wherein the first surface of the substrate has a display region and a peripheral region around the display region, the active devices are located within the display region, and the spacers are located within the peripheral region and surround the display region.

3. The active device array substrate as claimed in claim 1, further comprising at least one patterned metal layer disposed between the substrate and the spacers, and located over the active devices.

4. The active device array substrate as claimed in claim 1, further comprising an alignment layer disposed over the substrate and the active devices and covering the spacers, wherein the alignment layer has an alignment direction corresponding to the rubbing direction.

5. The active device array substrate as claimed in claim 1, wherein the substrate is a silicon substrate.

6. A common electrode substrate, comprising:
a substrate, having a second surface;
a common electrode layer, disposed on the second surface; and
a plurality of spacers, disposed on the common electrode layer, each of the spacers having two side surfaces opposite to each other, wherein a first normal vector of the second surface and a second normal vector of each of the side surfaces make an angle falling within a range from 40 degrees to 70 degrees, each of the two second normal vectors points away from the second surface, the common electrode substrate has a rubbing direction, and a rubbing vector along the rubbing direction and the two second normal vectors of the side surfaces are coplanar.

7. The common electrode substrate as claimed in claim 6, wherein the second surface of the substrate has a display region and a peripheral region around the display region, and the spacers are located within the peripheral region and surround the display region.

8. The common electrode substrate as claimed in claim 6, wherein the substrate is transparent.

9. The common electrode substrate as claimed in claim 6, further comprising an alignment layer disposed on the common electrode layer and covering the spacers, wherein the alignment layer has an alignment direction corresponding to the rubbing direction.

10. A reflective type liquid crystal panel, comprising:
an active device array substrate, comprising:
a first substrate, having a first surface;
a plurality of active devices, arranged in an array on the first surface;
a plurality of spacers, disposed over the first surface, each of the spacers having two side surfaces opposite to each other, wherein the first surface faces the active devices, a first normal vector of the first surface and a second normal vector of each of the side surfaces make an angle falling within a range from 40 degrees to 70 degrees, and each of the two second normal vectors points away from the first surface; and
a first alignment layer, disposed over the first substrate and the active devices and covering the spacers, wherein the first alignment layer has an alignment direction corresponding to a rubbing direction, and a rubbing vector along the rubbing direction and the two second normal vectors of the side surfaces are coplanar;
a common electrode substrate, comprising:
a second substrate, having a second surface facing the active device array substrate;
a common electrode layer, disposed on the second surface; and
a second alignment layer, disposed on the common electrode layer; and
a liquid crystal layer, disposed between the first alignment layer and the second alignment layer.

11. The reflective type liquid crystal panel as claimed in claim 10, wherein the first surface of the first substrate has a display region and a peripheral region around the display region, the active devices are located within the display region, and the spacers are located within the peripheral region and surround the display region.

12. The reflective type liquid crystal panel as claimed in claim 10, wherein the active device array substrate further comprises at least one patterned metal layer disposed between the first substrate and the spacers, and located between the first substrate and the first alignment layer and over the active devices.

13. The reflective type liquid crystal panel as claimed in claim 10, further comprising a sealant disposed between the active device array substrate and the common electrode substrate, wherein the sealant wraps the spacers and surrounds the liquid crystal layer.

14. The reflective type liquid crystal panel as claimed in claim 10, wherein the first substrate is a silicon substrate.

15. The reflective type liquid crystal panel as claimed in claim 10, wherein the second substrate is transparent.

16. An reflective type liquid crystal panel, comprising:
an active device array substrate, comprising:
a first substrate, having a first surface;
a plurality of active devices, arranged in an array on the first surface; and
a first alignment layer, disposed over the first substrate and the active devices, wherein the first surface faces the first alignment layer;
a common electrode substrate, comprising:
a second substrate, having a second surface facing the active device array substrate;
a common electrode layer, disposed on the second surface;
a plurality of spacers, disposed on the common electrode layer, each of the spacers having two side surfaces opposite to each other, wherein a first normal vector of the second surface and a second normal vector of each of the side surfaces make an angle falling within a range from 40 degrees to 70 degrees, and each of the two second normal vectors points away from the second surface; and
a second alignment layer, disposed on the common electrode layer and covering the spacers, wherein the second alignment layer has a alignment direction corresponding to a rubbing direction, and a rubbing vector along the rubbing direction and the two second normal vectors of the side surfaces are coplanar; and
a liquid crystal layer, disposed between the first alignment layer and the second alignment layer.

17. The reflective type liquid crystal panel as claimed in claim 16, wherein the second surface of the second substrate has a display region corresponding to the active devices and a peripheral region around the display region, and wherein the spacers are located within the peripheral region and surround the display region.

18. The reflective type liquid crystal panel as claimed in claim 16, wherein the active device array substrate further comprises at least one patterned metal layer disposed between the first substrate and the first alignment layer and over the active devices.

19. The reflective type liquid crystal panel as claimed in claim 16, further comprising a sealant disposed between the active device array substrate and the common electrode substrate, wherein the sealant wraps the spacers and surrounds the liquid crystal layer.

20. The reflective type liquid crystal panel as claimed in claim 16, wherein the first substrate is a silicon substrate.

21. The reflective type liquid crystal panel as claimed in claim 16, wherein the second substrate is transparent.
